(19) United States
(12) Patent Application Publication
(10) Pub. No.: US 2011/0016962 A1
(43) Pub. Date: Jan. 27, 2011

(54) Detector for Characterizing a Fluid

(75) Inventor: Rocco DiFoggio, Houston, TX (US)

Correspondence Address: Mossman, Kumar and Tyler, PC, P.O. Box 421239, Houston, TX, 77242, US

(73) Assignee: BAKER HUGHES INCORPORATED, Houston, TX (US)

(21) Appl. No.: 12/839,920

(22) Filed: Jul. 20, 2010

Related U.S. Application Data
(60) Provisional application No. 61/227,329, filed on Jul. 21, 2009.

(51) Int. Cl. G01N 23/00

(52) U.S. Cl. 73/152.15

(57) ABSTRACT

An apparatus for characterizing a fluid property in a vessel may include a first member and a second member. The first member and the second member may be oriented at a non-zero angle. The second member may be responsive to the motion of the first member, and the first member may be acoustically coupled to the fluid by the vessel. Also, a method for characterizing the fluid includes using the response of the second member to estimate the fluid property.

### CROSS-REFERENCES TO RELATED APPLICATIONS

This application claims priority from U.S. Provisional Patent Application Ser. No. 61/227,329 filed on 21 Jul. 2009.

### BACKGROUND OF THE DISCLOSURE

1. Field of Disclosure

The present disclosure generally relates to the field of reservoir characterization and the analysis of fluids obtained in a wellbore. More specifically, the present disclosure relates to estimating the composition of a fluid.

2. Description of the Related Art

To obtain hydrocarbons such as oil and gas, boreholes are drilled into the earth by rotating a drill bit attached to the end of a drill string. Modern directional drilling systems generally employ a drill string having a bottom hole assembly (BHA) and a drill bit at an end thereof that is rotated by a drill motor (mud motor) and/or by rotating the drill string. A number of downhole devices placed in close proximity to the drill bit measure certain downhole operating parameters associated with the drill string. Such devices typically include sensors for measuring downhole temperature and pressure, azimuth and inclination measuring devices and a resistivity-measuring device to determine the presence of hydrocarbons and water. Additional downhole instruments, known as logging-while-drilling (LWD) tools or measurement-while-drilling (MWD) tools, are attached to the drill string to determine the formation geology formation fluid characteristics and conditions during the drilling operations. Wireline logging tools are typically used after the drilling of the wellbore to determine formation geology and formation fluid characteristics.

Commercial development of hydrocarbon fields requires significant amounts of capital. Before field development begins, operators desire to have as much data as possible regarding the nature of the hydrocarbon formation in order to evaluate the reservoir for commercial viability. Despite the advances in data acquisition during drilling using the MWD tools and the analysis done by wireline tools after drilling the well, it is often necessary to analyze formation fluid. These samples are analyzed to estimate the characteristics and/or compartmentalization of a reservoir or wellbore.

### SUMMARY OF THE DISCLOSURE

The present disclosure is directed to methods and apparatuses for estimating at least one property of a fluid sample obtained from a wellbore using the absorption of light of a specific wavelength that is pulsed on and off at a desired frequency to generate photoacoustic vibrations that may be detected by a detector that is in acoustic communication with the walls of the fluid's container (vessel) and may be shaped to maximize its sensitivity to vibrations of the vessel wall.

One embodiment according to the present disclosure includes an apparatus for characterizing a fluid received by a vessel, comprising: a detector configured to be operably coupled to the vessel, the detector including a first member and a second member oriented at a non-zero angle relative to the first member, the second member being responsive to a motion of the first member.

Another embodiment according to the present disclosure includes a method for characterizing a fluid in a vessel, comprising: detecting a response of a detector operably coupled to the vessel, the detector including a first member, and a second member, wherein the second member is oriented at a non-zero angle with the first member, and wherein a motion of the second member is responsive to a motion of the first member.

The above-recited examples of features of the disclosure have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, references should be made to the following detailed descriptions of the disclosed embodiments, taken in conjunction with the accompanying drawings, in which like elements have been given like numerals and wherein:

FIG. 1 illustrates an apparatus according to one embodiment of the present disclosure;

FIG. 2 illustrates an apparatus according to another embodiment of the present disclosure;

FIG. 3 illustrates a schematic diagram according to one embodiment of the present disclosure deployed in a downhole environment;

FIG. 4 illustrates an elevation view of an offshore drilling system according to one embodiment of the present disclosure that utilizes a rigid carrier to convey tools; and

FIG. 5 is an illustration of a wireline diagram of one embodiment of the present disclosure.

### DETAILED DESCRIPTION OF THE DISCLOSURE

The present disclosure provides a method and apparatus for estimating a property of a fluid based on the fluid's absorption of light at one or more specified wavelengths. The absorption of energy at the specific wavelength may induce photoacoustic vibrations in the fluid, which may be detected by a detection device, such as a meter or acoustic resonator. By placing an acoustic detection device in acoustic communication with the fluid, the acoustic detection device may indicate whether a specific substance is present in the fluid. As should be appreciated, however, the present disclosure may be advantageously applied to a variety of testing and analysis applications unrelated to those used in connection with fluid composition estimation.

Photoacoustic spectroscopy (PAS) is a highly sensitive absorption-spectroscopic technique. PAS involves the absorption of light energy by a molecule and the subsequent detection of a pressure wave caused by heat energy released by the molecule upon return to the ground state. The sensitivity of PAS arises from the inherently high efficiency of thermal conversion that occurs in most such light-absorption processes coupled with a similar efficiency in the piezoelectric devices that convert the pressure wave into a signal. In addition to a light source, which is often a laser, a PAS device typically includes a framework to hold the sample and the acoustic detection device in acoustic communication. In one embodiment, the storage of the fluid under pressure in a vessel provides acoustic communication between the fluid and the acoustic detection device mounted on the vessel. The pressure pulses generated in the fluid are then converted to a signal that may be processed by suitable electronics. The signal may be an electrical signal such as a voltage pulse.

Embodiments of the present disclosure may use Quartz-Enhanced Photoacoustic Spectroscopy (QEPAS), a technique that inverts the common approach to resonant PAS by accumulating the absorbed energy not in the fluid but in an acoustic detection device (such as a resonant microphone). A well-suited material for an acoustic detection device may be piezoelectric crystal quartz. As virtually all materials have a resonance frequency, one of ordinary skill in the art may recognize that while some materials may be better suited for resonant PAS than others, resonant PAS may be achieved with any materials that possess the appropriate stiffness such that an induced resonant signal may be detected above ambient noise. The use of a resonant PAS element may enhance the detection of photoacoustic vibrations.

Information about the composition of the sample fluid may assist oil producers to decide on how to develop a reservoir (well location, types of production facilities, etc.). Oil producers want to know whether different sections of a reservoir are separate compartments (across which fluids do not flow) or whether they are connected. Separate compartments are drained separately and may need different types of processing for their fluids. Thus, there is a need for methods and apparatus for determining whether or not a reservoir is compartmentalized.

Photoacoustic spectroscopy (PAS) is an analytical method that involves stimulating a sample fluid by light and subsequently detecting sound waves emanating from the sample. Typically, only a narrow range of wavelengths of light are introduced into the sample fluid. Such narrow range of wavelengths of light can be formed by, for example, a laser. Utilization of only a narrow range of wavelengths can enable pre-selected molecular transitions to be selectively stimulated and studied.

A photoacoustic signal may occur as follows. First, light stimulates a molecule within a sample. Such stimulation can include, for example, absorption of the light by the molecule to change an energy state of the molecule. Second, an excited state structure of the stimulated molecule rearranges. During such rearrangement, heat, light, volume changes and other forms of energy can dissipate into an environment surrounding the molecule. Such forms of energy cause expansion or contraction of materials within the environment. As the materials expand or contract, sound waves are generated.

In order to produce a series of sound waves or photoacoustic signals, the light is pulsed or modulated, at half the resonant frequency, f, of the acoustic resonator. Accordingly, an acoustic detector, such as an acoustic resonator, mounted in acoustic communication with the environment can detect changes occurring as a result of the light stimulation of the absorbing molecule concentration or signal.

Because the amount of absorbed energy is proportional to the concentration of the absorbing molecules, the acoustic signal can be used for concentration measurements.

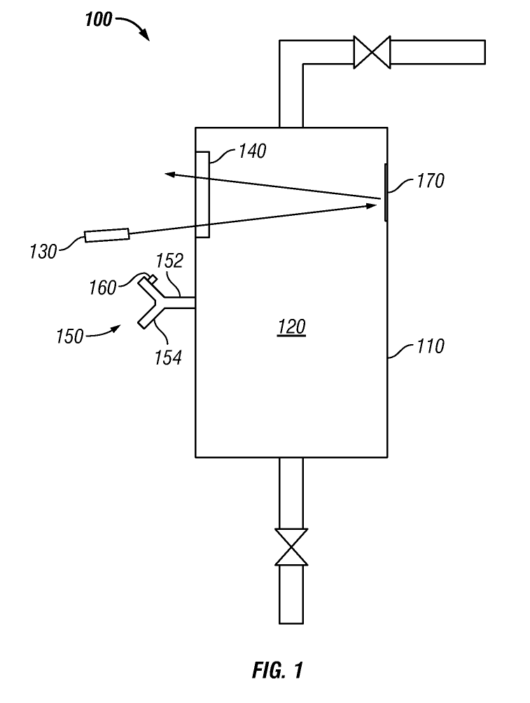

As shown in FIG. 1, in one embodiment according to the present disclosure, the PAS apparatus 100 may include a vessel 110 to receive a fluid 120. Herein, the term vessel is means any structure suitable for containing a fluid sample. The fluid sample may be stationary in and/or flowing in or through the vessel without departing from the scope of the disclosure. The vessel may be a fixed component of the apparatus 100 or a removable component. A pulsed electromagnetic radiation source 130 may be directed into the fluid 120 through an optical window 140 in vessel 110. The electromagnetic radiation source induces pulses in the fluid by providing energy at a specific wavelength of electromagnetic radiation that will be absorbed by at least one selected substance in the fluid 120. If one or more selected substances are present in the fluid 120, then the electromagnetic energy may be absorbed by the substance in fluid 120. When energy is absorbed by the substance in the fluid 120, it may be converted to heat, which may produce acoustic pulses within the fluid 120. These pulses may cause the walls of vessel 110 to vibrate.

Coherent electromagnetic radiation may be used as the pulsed electromagnetic radiation source 130 to optimize the amount of energy transmitted into the fluid. The pulsed electromagnetic radiation source 130 may operate at any wavelength desired to induce acoustic pulses in the fluid. The pulsed electromagnetic radiation source 130 is not restricted to the visual portion of the electromagnetic spectrum. Similarly, optical window 140 allows the transmission of electromagnetic radiation throughout the desired range of the electromagnetic spectrum and may or may not be transparent to visible electromagnetic radiation. For example, a window made of silicon or germanium will transmit infrared light but will act as a shiny reflector (mirror) for visible light. The pulsed electromagnetic radiation source 130 may use, but is not limited to, at least one of: (i) a laser, (ii) a collimated light beam, (iii) a filtered strobe, and (iv) a high-intensity LED.

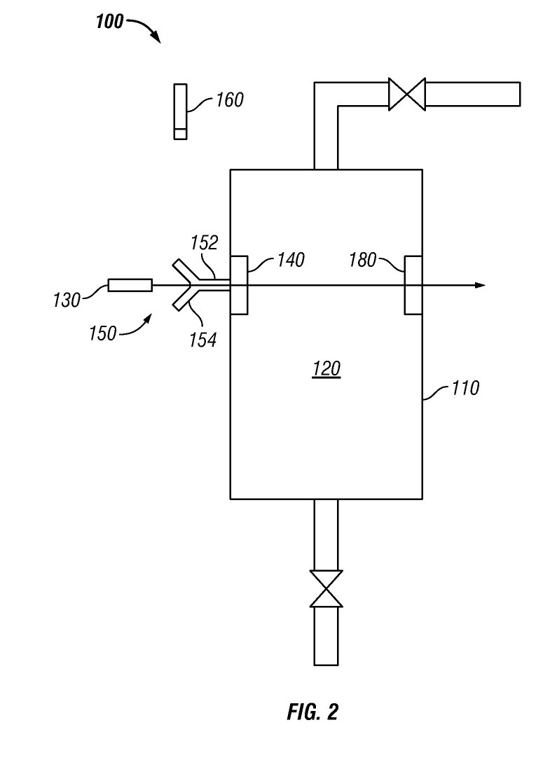

To prevent errant vibrations induced by electromagnetic radiation pulses impinging on interior of the vessel 110, in one embodiment, a reflective surface 170 may be used to reflect unabsorbed electromagnetic radiation out the optical window 140. In another embodiment, shown in FIG. 2, vessel 110 has two optical windows 140, 180, wherein the first optical window 140 allows the entry of the electromagnetic radiation, and the second optical window 180 allows the exit of any unabsorbed electromagnetic radiation.

Returning to FIG. 1, vibrations in the walls of vessel 110 are received by a detector, such as an acoustic detection device 150 that is operably coupled to the vessel 110. By “operably coupled,” it is general meant that the response of the fluid in the vessel 110 to the applied electromagnetic radiation is communicated via the vessel 110 to the acoustic detection device 150. In some aspects, acoustic detection device 150 may include a first member 152 and a second member 154. First member 152 and second member 154 may be portions of a single body or formed from one or more pieces. The first member 152 may be coupled to the vessel 110, while the second member 154 is coupled to the first member 152 such that the second member 154 may not align with the first member 152. For example, the first member 152 may have a non-zero angle relative to the second member 152. In such embodiments, the non-zero angle causes the second member 152 to arc or rotate around the first member 152 such that a bending moment may be induced in the second member 154 when the first member 152 is exposed to force directed along its length.

In one non-limiting embodiment, the detector may be a Y-shaped flexural resonator 150, as shown, though this shape is illustrative and exemplary only. That is, other shapes that have members at non-zero relative angles may also be used. For instance, other acoustic detection devices and shapes other than Y-shaped acoustic resonators may be used, such as transducers and sound meters. Additionally, if an acoustic resonator is used, the acoustic resonator need not be Y-shaped, but may have a different shape, such as U-shaped, T-shaped, W-shaped, Gamma-shaped, and fractal-shaped. As used here, the term “Y-shaped” generally indicates that the tines of a flexural resonator are not in parallel alignment. In some aspects, a flexural resonator may have a plurality of tines (e.g., two or more tines). The center of mass of each tine of the flexural resonator has an enhanced lever arm (moment arm) with respect to the point of contact of the flexural resonator “stalk” (i.e., handle) with the wall of the fluid's container so as to provide enhanced torque for swinging the tines back and forth in response to up and down motion of the stalk of the fork and thereby may provide enhanced sensitivity of the resonator to any motion of the container wall. Additional resonator configurations include, but are not limited to, “T-shaped,” “W-shaped,” “Gamma-shaped,” and “Fractal-shaped.” Furthermore, the tines need not be coplanar. Each tine simply needs to have its center of mass offset relative to the point of contact of the fork stalk with the wall of the container so as to provide a torque that is proportional to that offset.

When using a detector or detection device that responds to vibrations in a narrow frequency band (i.e., resonance frequency), it may be desirable for the portion of the device that may resonate to have an increased mechanical moment in a direction responsive to the vibration. It would be understood by one of ordinary skill in the art that, if the second member 154 of the flexural resonator 150 includes tines, vibrating the flexural resonator 150 in a direction parallel to the tines would produce a less pronounced response than if the tines were positioned to have a perpendicular directional component. In some aspects, a larger perpendicular directional component may result in a greater response. This is not to say that maximizing the perpendicular directional component (i.e., at T-shape) is necessarily superior, however, the presence of a perpendicular directional component in the second member 154, for at least some embodiments, may be desirable over a flexural resonator with no perpendicular directional component at all (i.e., parallel directional component only).

In this embodiment, the pulsed electromagnetic radiation source 130, while having a wavelength corresponding to the desired substance for detection within the fluid 120, may be tuned to pulse at the half resonance frequency of the Y-shaped flexural resonator 150. The Y-shaped flexural resonator 150 may be acoustically coupled to a wall of the vessel 110 so that vibrations from the fluid 120 may be transferred to the resonator 150.

When the desired substance is present in the fluid 120, then the vibrations induced in the walls of vessel 110 may cause Y-shaped flexural resonator 150 to vibrate at its resonance frequency. This resonance vibration may be estimated by a sensor 160 adapted to detect the vibrations in the Y-shaped flexural resonator 150. In some embodiments, the flexural resonator may not be used at all, but the vibration may be measured directly from the wall of the vessel 110 by sensor 160.

In some aspects, sensor 160 may detect sound generated by the acoustic detection device 150. In other aspects, sensor 160 may detect electrical energy generated by the acoustic detection device 150. In aspects where the acoustic detection device 150 generates electrical energy, due to the inclusion of a piezoelectric material in the acoustic detection device 150, the sensor 160 may placed in electrical communication with the second member 154. In one aspect, electrical leads of the sensor 160 may be a thin film on the surface of the flexural resonator 150.

In one aspect, shown in FIG. 2, the Y-shaped flexural resonator 150 may be located in the path of the beam from the pulsed electromagnetic radiation source 130 at the optical window 140, such that the pulsed electromagnetic radiation passes through the stalk 152 of the Y-shaped flexural resonator 150. The stalk 152 may be acoustically coupled to the optical window 140. This is illustrative and exemplary, as the acoustic detection device may be place anywhere as long as acoustic communication with the fluid is maintained. In this embodiment, the Y-shaped flexural resonator 150 may be composed of a material that will not absorb the energy from the pulsed electromagnetic radiation source 130. In an alternative embodiment, the sensor 160 may be directed at the vessel 110 and detect sound generated by the vibration of the vessel 110 without using flexural resonator 150 to amplify the vibrations.

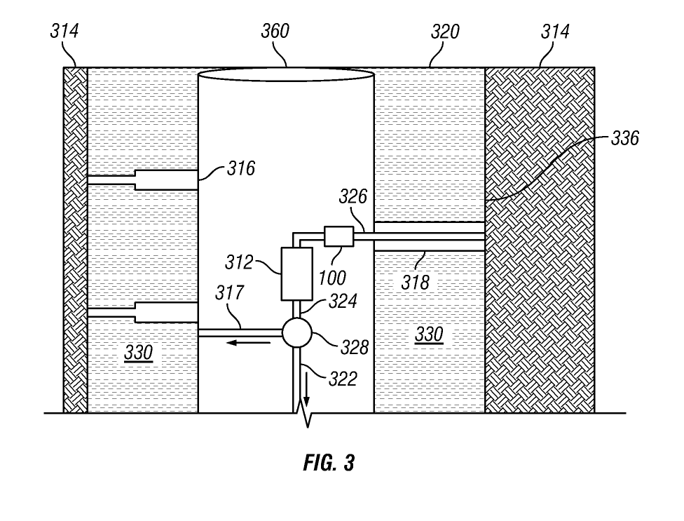

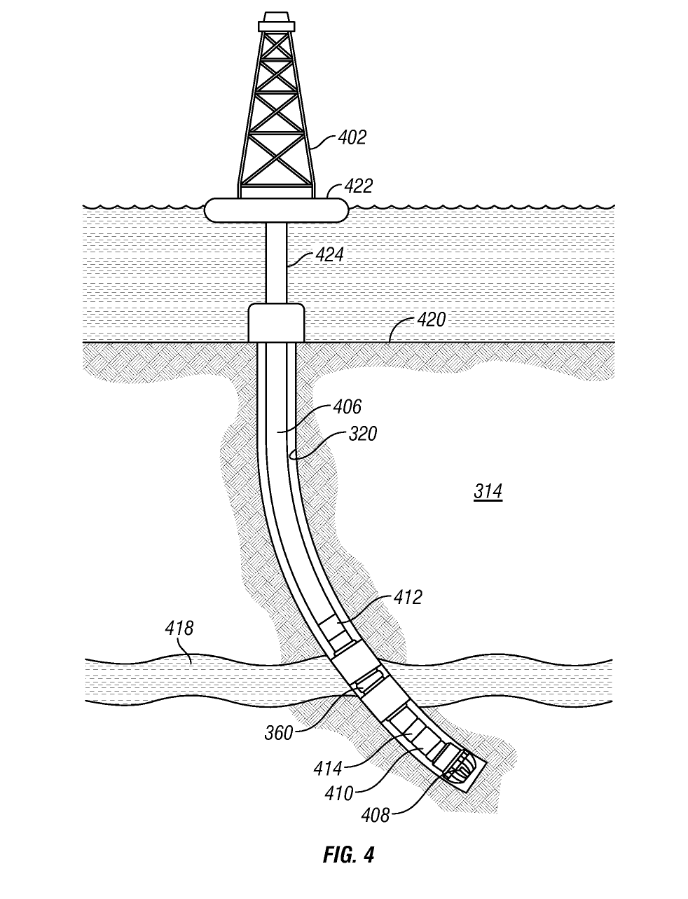

FIG. 3 is a schematic diagram of one embodiment of the present disclosure as deployed from a wireline downhole environment showing a cross section of a wireline formation tester tool. As shown in FIG. 3, the fluid analysis tool 360 is deployed in a borehole 320 filled with borehole fluid 330. The fluid analysis tool 360 is positioned within a hydrocarbon production zone 418 (see FIG. 4) in the borehole by backup arms 316. A packer with a snorkel 318 contacts the borehole wall 336 for extracting formation fluid from the formation 314. Wellbore fluid 330 can be drawn from the wellbore also by not extending the snorkel 318 to the wall and pumping fluid from the wellbore 320 instead of the formation 314. Fluid analysis tool 360 contains PAS apparatus 100, shown in FIGS. 1 and 2, disposed in flow line 326. The PAS apparatus 100 estimates the presence and/or concentrations of one or more select substances in the formation fluid. Pump 312 pumps formation fluid from formation 314 into flow line 326. Formation fluid travels through flow line 324 into valve 328, which directs the formation fluid to line 322 to save the fluid in sample tanks or to line 317 where the formation fluid exits to the borehole.

FIG. 4 is a drilling apparatus according to one embodiment of the present disclosure. A typical drilling rig 402 with a borehole 320 extending therefrom is illustrated, as is well understood by those of ordinary skill in the art. The drilling rig 402 has a work string 406, which in the embodiment shown is a drill string. The drill string 406 has attached thereto a drill bit 408 for drilling the borehole 320. The present disclosure is also useful in other types of work strings, and it is useful with a wireline, jointed tubing, coiled tubing, or other small diameter work string such as snubbing pipe. The drilling rig 402 is shown positioned on a drilling ship 422 with a riser 424 extending from the drilling ship 422 to the sea floor 420. However, any drilling rig configuration such as a land-based rig may be adapted to implement the present disclosure.

If applicable, the drill string 406 can have a downhole drill motor 410. Incorporated in the drill string 406 above the drill bit 408 is a typical testing unit, which can have at least one sensor 414 to sense downhole characteristics of the borehole, the bit, and the reservoir, with such sensors being well known in the art. A useful application of the sensor 414 is to determine direction, azimuth, and orientation of the drill string 406 using an accelerometer or similar sensor. A telemetry system 412 is located in a suitable location on the work string 406 such as above the fluid analysis tool 360. The telemetry system 412 is used for command and data communication between the surface and the fluid analysis tool 360.

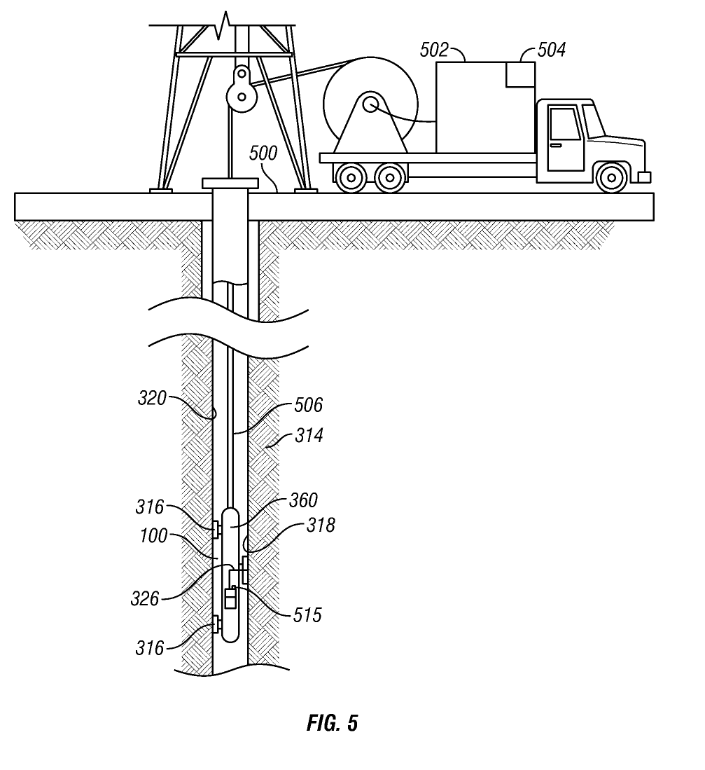

FIG. 5 is a schematic diagram of one embodiment of the present disclosure deployed on a wireline in a downhole environment. The PAS apparatus 100 may be housed in a fluid analysis tool 360 or alternatively be housed at the surface in controller 502. FIG. 5 illustrates an example of one embodiment of the present disclosure deployed from a wire line 506 in a borehole 320 drilled in a formation 314. A snorkel 318 extracts fluid from the formation 314. The extracted formation fluid flow through flow line 326 where the PAS apparatus 100 estimates the presence and/or concentration of one or more select substances in the formation fluid. Backup arms 316 hold the fluid analysis tool 360 and snorkel 318 in place during extraction of a formation fluid sample. The results of the fluid analysis performed by the PAS apparatus 100 may be acted on by a processor 515 or the sample can be sent to the surface 500 to by a PAS analysis module 504 at the surface processor and control unit 502.

In one aspect, a fluid may be pumped or extracted from a formation into a vessel for testing for the presence or concentration of one or more selected substances. Once the fluid is received by the vessel, a beam of coherent electromagnetic radiation may be directed into the fluid through an optical window in the vessel from a coherent electromagnetic radiation source. The electromagnetic radiation is specially tuned to a desired frequency that will interact with one or more selected substances but not with other components of the fluid. If the one or more selected substances are not present, then the beam will pass through the fluid and out of the vessel through the original optical window or a second optical window. However, if one or more of the selected substances are present, then the one or more substances will absorb the energy from the beam, which will be converted to heat. As the one or more substances heat, they will generate a pressure pulse, which will induce a vibration in the fluid that will be transferred to the vessel and to a flexural resonator coupled to the exterior of the vessel. Since the beam is pulsed, the absorption of the energy by the one or more substances will result in a series of pressure pulses. The beam is pulsed at the resonance frequency of a flexural resonator that is coupled to the exterior of the vessel. As long as the one or more substances are present in the fluid, the beam energy will result pressure pulses that may be transferred to the flexural resonator, and the strength of these pulses will vary with the concentration of the one or more substances in the fluid. Thus, the presence and the concentration of one or more selected substances may be monitored by measuring the strength of a signal generated by the flexural resonator. By pulsing the beam at the resonance frequency of the flexural resonator, the signal generated by the flexural resonator when the one or more substances are present will be significantly higher than ambient noise that may be transferred to the vessel and the flexural resonator during ordinary operations.

It should be understood, however, that the uses described above are illustrative and not limiting. That is, embodiments according to the present disclosure may be utilized in connection with reservoir management devices, permanently installed sub-surface devices, and/or devices that are generally stationary for a period of time. Moreover, embodiments of the present disclosure may be used in connection with estimating one or more parameters for subsurface and/or surface fluids that may include, but are not limited to, fluids from geothermal sources, water, hydrocarbons, liquids, gases, plasmas, mixtures of fluids, naturally occurring fluids, human-made fluids, etc.

From the above, it should be appreciated that what has been described includes, in part, an apparatus for characterizing a fluid received by a vessel. The apparatus may include a detector configured to be operably coupled to the vessel. The detector may include a first member and a second member oriented at a non-zero angle relative to the first member, the second member being responsive to a motion of the first member.

From the above, it should be appreciated that what has been described also includes, in part, a method for characterizing a fluid received by a vessel. The method may include detecting a response of a detector operably coupled to a vessel, wherein the detector may include a first member and a second member oriented at a non-zero angle relative to the first member, the second member being responsive to a motion of the first member.

From the above, it should be appreciated that what has been described further includes, in part, an apparatus for characterizing a fluid. The apparatus may include a vessel configured to receive the fluid, a source configured to direct a beam of electromagnetic energy into the vessel, and a sensor configured to detect a response of the vessel to a response of the fluid.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. Thus, it is intended that the following claims be interpreted to embrace all such modifications and changes.

We claim:

1. An apparatus for characterizing a fluid received by a vessel, comprising:
a detector configured to be operably coupled to the vessel, the detector including a first member and a second member oriented at a non-zero angle relative to the first member, the second member being responsive to a motion of the first member.

2. The apparatus of claim 1, further comprising a sensor configured to detect a response of the second member to a bending moment.

3. The apparatus of claim 1, wherein the detector includes one or more of: a Y-shape, a T-shape, a W-shape, a Gamma-shape, and a fractal-shape.

4. The apparatus of claim 1, further comprising a source configured to direct a beam of electromagnetic radiation into the vessel.

5. The apparatus of claim 4, wherein at least one parameter of the beam is selected to cause at least a portion of the beam to be absorbed by a selected substance.

6. The apparatus of claim 5, wherein the selected substance is at least one of: (i) an oil-based contaminant; and (ii) a component of an oil-based drilling fluid.

7. The apparatus of claim 1, wherein the response is a vibration.

8. The apparatus of claim 1, wherein the detector is mounted on an exterior surface of the vessel.

9. A method for characterizing a fluid, comprising:
detecting a response of a detector operably coupled to a vessel, the detector including a first member and a second member oriented at a non-zero angle relative to the first member, the second member being responsive to a motion of the first member.

10. The method of claim 9, further comprising: moving the first member by generating pressure pulses in the vessel.

11. The method of claim 9, further comprising directing electromagnetic radiation into the vessel.

12. The method of claim 11, wherein at least one parameter of the electromagnetic radiation is selected to cause at least a portion of the electromagnetic radiation to be absorbed by a selected substance.

13. The method of claim 12, wherein the selected substance is at least one of: (i) an oil-based contaminant; and (ii) a component of an oil-based drilling fluid.

14. The method of claim 9, wherein the response is a vibration.

15. The method of claim 9, wherein the response is motion of the second member due to an applied bending moment.

16. An apparatus for characterizing a fluid, comprising:
a vessel configured to receive the fluid;
a source configured to direct a beam of electromagnetic energy into the vessel; and
a sensor configured to detect a response of the vessel to a response of the fluid.

17. The apparatus of claim 16, wherein at least one parameter of the beam is selected to cause at least a portion of the beam to be absorbed by a selected substance.

18. The apparatus of claim 17, wherein the selected substance is at least one of: (i) an oil-based contaminant; and (ii) a component of an oil-based drilling fluid.

19. The apparatus of claim 16, wherein the response of the vessel is a vibration.
